(19) United States
(12) Patent Application Publication
(10) Pub. No.: US 2022/0361987 A1
(43) Pub. Date: Nov. 17, 2022

(54) RECTANGULAR-RETAINED-ARCH AND APPLYING METHODS

(71) Applicants: PRM LTD (ADVANCED MEDICAL SOLUTIONS), Holon (IL); STRAUSS & CO LTD, RA'ANANA (IL)

(72) Inventor: Yoav MAZOR, Holon (IL)

(73) Assignees: PRM LTD (ADVANCED MEDICAL SOLUTIONS), Holon (IL); STRAUSS & CO LTD, RA'ANANA (IL)

(21) Appl. No.: 17/738,714

(22) Filed: May 6, 2022

Related U.S. Application Data
(60) Provisional application No. 63/187,399, filed on May 11, 2021.

(51) Int. Cl. A61C 7/20

(52) U.S. Cl. CPC A61C 7/20

(57) ABSTRACT

A novel orthodontic apparatus is disclosed. The novel apparatus can be referred as a rectangular-retained arch (RRA). Examples of RRA can be used for stabilizing a new configuration of teeth so that the teeth do not move to an incorrect position. An example of RRA can have a shape of arch that is made of a single piece of material. Some embodiments of RRA can have a plurality of holes along the RRA.

### CROSS-REFERENCE TO RELATED APPLICATIONS

This utility patent application being filed in the United States as a non-provisional application for patent under Title 35 U.S.C. § 100 et seq. and 37 C.F.R. § 1.53(b) and, claiming the benefit of the prior filing date under Title 35, U.S.C. § 119(e) of the U.S. provisional application for patent that was filed on May 11, 21 and assigned the Ser. No. 63/187,399, which application is herein incorporated by reference in its entirety.

### FIELD OF THE DISCLOSURE

The present disclosure relates to the field of orthodontic treatment. More particularly the disclosure relates to a novel orthodontic technique for stabilizing the new configuration of teeth so that the teeth do not move to an incorrect position.

### BACKGROUND

Various orthodontic procedures move or adjust the position of teeth within a patient's mouth. Once the movement of one or more teeth is finished, then preventive measures need to be taken in order to avoid the teeth for moving back toward the original location or to an intermediate position between the initial position and the final position, which was attained after the procedures. In other cases, due to loss of bone support, teeth are required to be connected together to enhance their resistance to mastication and other function.

Thus, after moving and positioning the teeth in the correct position, there is a need to hold them in that position. Because the teeth tend to return to their original position (relapse). Holding the teeth in the new position allows the bone, and the soft tissues (gingiva) around the teeth, to rebuild and stabilize around the new position. Retention can be accomplished by use of a retainer wire that holds the teeth in their new position for long duration of time and enables the bone and soft tissues to reform around their new positions and to prevent the relapse.

A common technique for holding teeth in their new location is by using a fixed retainer. An example of a common retained can be a metallic wire that is attached to the lingual or buccal side of the teeth, which are required to be retained.

Handling a fix retainer is complicated and may lead to imprecise positioning, poor adjustment, actively move the teeth, detach from the teeth and other such problems. These processes can be difficult to perform and can also require special knowledge by the treatment professional to perform.

Some example methods for keeping the teeth in the new position are using a rectangular-retained wire (RRW). The RRW supports the teeth better than a round cross cut retainer wire; however it is more complicated to adapt accurately the RRW to the teeth and giving it the shape of the teeth surfaces on which the RRW is bonded to. Further, common RRW is made of a soft metal or soft alloy such as but not limited to Nickle-Titanium (NiTi). It is well known to a person having ordinary skill in the art that NiTi is a shape-memory alloy, Common temperature in which the NiTi start moving toward its original shape (the pre-deformation shape) is around 40 degrees Celsius. Thus, there is a risk that in the temperature of the mouth a common RRW may start transforming putting pressure on the teeth and may cause them to move instead of keeping the teeth their new location. In the following description, the terms “metal”, “alloy,” “soft metal”, and “soft alloy” may be used interchangeably.

Further, it is well known to a person having ordinary skill in the art that due to the appearance and the uncomfortable feeling that is associated with the orthodontic appliance, patients and especially children do not like to use them. In some cases the inconvenience leads to a dis-satisfactory results or in extreme cases, the patient may withdraw in the middle of the treatment.

### BRIEF SUMMARY

The needs and the deficiencies that are described above are not intended to limit the scope of the inventive concepts of the present disclosure in any manner. The needs are presented for illustration only. The disclosure is directed to a novel apparatus and method for preserving the location of teeth after an orthodontic treatment.

An example embodiment of the disclosed technique can be referred as a rectangular-retained arch (RRA). The novel RRA can have a shape of a vertical arch in one or more sizes. The vertical dimension refers to the dimension in which the RRA is fixed at the jaw of the patient. The size of each arch can be defined by its height and the distance between it's two ends. The height of the arch ‘H’ is define as the distance from the top of the arch to the virtual line that connects the two ends of the arch. The width ‘W’ of an RRA can be in the range of 0.8 to 1.3 mm, 1.2 mm for example. An example of an upper RRA may have the size of 38 mm±4 mm and the height can be in the range of 10±2 mm, for example. An example of bottom RRA can have the size 33 mm±4 mm and the height can be in the range of 10±2 mm, for example.

An example embodiment of an RRA may have a line of holes along the center line of the arch. Other example embodiments of an RRA may have two lines of holes, one in each side of the central line of the arch. In such example embodiment the holes can be arrange in a Zig-Zag around the central line. The dimeter of a hole can be in the range of 0.2 to 0.4 mm, 0.36 mm for example.

The holes are used to improve the bonding of the RRA to the teeth. During attaching the RRA to the teeth the bonding agent can penetrate via the holes to the other side of the RRA and creates a kind of a cap that improves the holding (bonding) of the RRA. A second layer of bonding agent can be placed over the RRA to cover the RRA and increase the total bonding strength. In addition, during manufacturing an RRA, it can be sandblasted to roughen it's surface and increase the contact surface with the bonding agent.

In order to bond the RRA to the teeth a doctor may use as an intermediate layer between the teeth surfaces, initially prepared (cleaned and etched with 34-38% phosphoric acid), a fluid bonding agent such as but not limited to ‘GC Ortho connect flow’, ‘3M transport LT’, etc. ‘GC Ortho connect flow’ is a trademark of GC Orthodontics Europe GnbH Germany. ‘3M transport LT’ is a trademark of 3M USA.

An example of RRA can be made of a single piece of material. The material can be an alloy such as but not limited to NiTi. NiTi is a shape-memory alloy. However the disclosed RRA is made of a unique NiTi alloy that is configured to start changing to its pre-deformation shape at a temperature of 70 or more degrees Celsius. Thus, in body temperature, which is below 40 degrees Celsius, the shape of the bonded RRA is stable and is able to keep the teeth in the new position. The pre-deformation temperature of an example of RRA may be 80 degrees Celsius. An example of such NiTi alloy is manufactured by Smart Beijing, China. Further, some embodiments of RRAs are delivered as unites, which are cut to the size of the required vertical arch. Some embodiments of RRA may have double arch shape.

These and other aspects of the disclosure will be apparent in view of the attached figures and detailed description. The foregoing summary is not intended to summarize each potential embodiment or every aspect of the present invention, and other features and advantages of the present invention will become apparent upon reading the following detailed description of the embodiments with the accompanying drawings and appended claims.

Furthermore, although specific embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

### BRIEF DESCRIPTION OF THE DRAWINGS

Some examples of embodiments of the present disclosure will be understood and appreciated more fully from the following detailed description, taken in conjunction with the drawings in which:

FIG. 1 schematically illustrates an example of RRA when it is placed on a plane;

FIG. 2 schematically illustrates a side and cross-sectional view of an example of RRA along line 2-2;

FIG. 3 illustrates a picture of an example of RRA bonded to a bottom jaw of a patient; and

FIG. 4 schematically illustrates a flowchart showing relevant processes that can be implemented for bonding an example of RRA to a jaw of a patient.

### DETAILED DESCRIPTION OF SOME EXAMPLE EMBODIMENTS

Turning now to the figures in which like numerals represent like elements throughout the several views, in which exemplary embodiments of the disclosed techniques are described. For convenience, only some elements of the same group may be labeled with numerals.

The purpose of the drawings is to describe examples of embodiments and not for production purpose. Therefore, features shown in the figures are chosen for convenience and clarity of presentation only. In addition the figures are drawn out of scale. Moreover, the language used in this disclosure has been principally selected for readability and instructional purposes, and may not have been selected to define or limit the inventive subject matter, resort to the claims being necessary to determine such inventive subject matter.

In this specification, these implementations, or any other form that the invention may take, may be referred to as techniques. In general, the order of the steps of disclosed processes may be altered within the scope of the invention. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following description, the words “unit,” “element,” “module”, and “logical module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of, or any combination of, hardware configured to execute the task ascribed to the unit or module. In the present disclosure the terms task, method, and process can be used interchangeably. In addition the terms element and section can be used interchangeably.

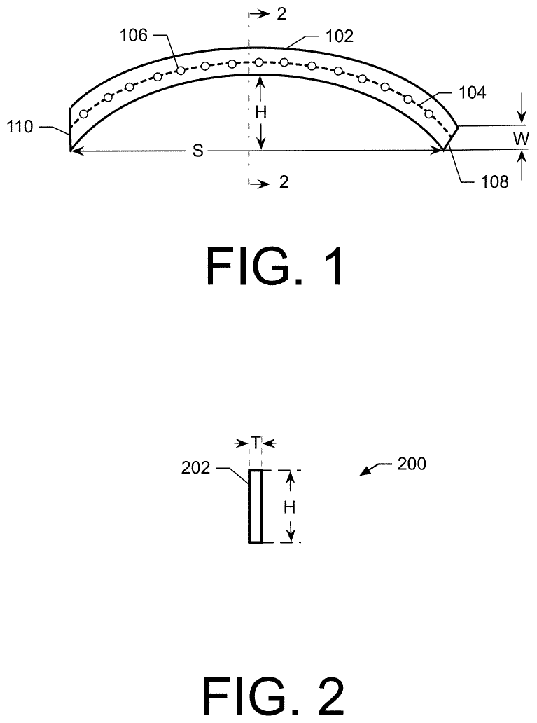

FIG. 1 schematically illustrates an example of RRA 102 when it is placed on a plane. The novel RRA 102 can have a shape of a vertical arch in one or more sizes. The vertical dimension is defined based on the state when the RRA 102 is bond to the jaw of the patient. Further, those RRA delivered as separated unites. Each unit has an arch shape, which is cut to the size of the required vertical arch

The size of arch 102 is defined by the distance ‘S’ between the two ends (108 and 110) of the arch 102. The height of the arch ‘H’ is define as the distance from the top of the arch to the virtual line that connects the two ends of the arch 108 and 110. The width ‘W’ of an RRA 102 can be in the range of 1.1 to 1.3 mm, 1.2 mm for example. The thickness ‘T’ (FIG. 2) of an example of RRA 102 can be in the range of 0.13 to 0.19 mm, 0.15 mm for example.

Along the present disclosure and the claims the term upper RRA refers to an RRA which is configured to be attached to the upper jaw and the term bottom RRA refers to an RRA which is configured to be attached to the bottom jaw. Usually an upper RRA 102 is bigger than a bottom RRA for the same person. The size ‘S’ of an upper RRA 102 can be in the range of 34 to 42 mm, 38 mm for example. The height ‘H’ of an upper RRA 102 can be in the range of 8 to 12 mm, 10 mm for example. The size of an example of bottom RRA can be in the range of 30 to 36 mm, 33 mm for example. The height ‘H’ of a bottom RRA can be in the range of 8.5 to 9.5 mm, 9 mm for example.

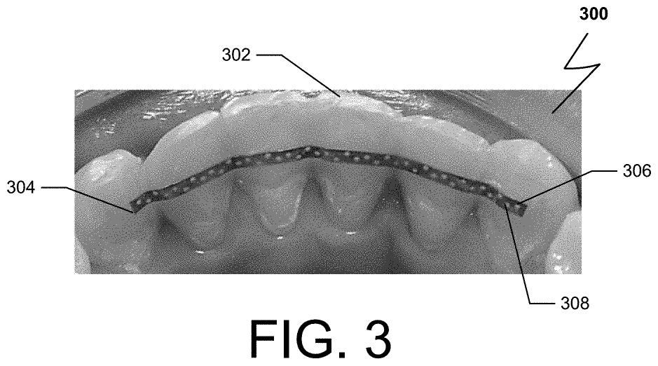

An example embodiment of an RRA 102 may have a line of holes 106 along the center line 104 of the arch. Other example embodiments of an RRA 304 may have two lines of holes, one in each side of the central line of the arch as it is illustrated in FIG. 3 holes 306 and 308. In such example embodiment, the holes can be arranged in a Zig-Zag around the central line. The dimeter of a hole 106 can be in the range of 0.3 to 0.4 mm, 0.36 mm for example.

Some example embodiments of RRA 102 can be made of a single piece of material. The material can be soft metal, such as but not limited to Nickle-Titanium (NiTi). Common NiTi alloy is shape-memory alloy. However the novel NiTi alloy is configured to start changing to its pre-deformation shape at a temperature of 65 or more degrees Celsius. Since the temperature in the oral cavity is 60 or below degrees Celsius the shape of the bonded RRA 102 is stable and is able to keep the teeth in their new position. An example of such NiTi alloy is manufactured by Smart Beijing, China. Further, the production of an example embodiment of RRA 102, may include sandblasted process. The sandblasted process may scratch the surface of the RRA 102 for improving the bonding of the RRA 102 to the relevant jaw.

FIG. 2 schematically illustrates a side and cross-sectional view 200 along line 2-2 of RRA 102 (FIG. 1). The thickness ‘T’ can be in the range of 0.13 to 0.19 mm, 0.15 mm for example. The width ‘W’ can be in the range of 1.1 to 1.3 mm, 1.2 mm for example

FIG. 3 shows a picture 300 of an example of RRA 304 bonded to the lingual side of a bottom jaw 302 of a patient. An example of RRA 304 can be made of a single piece of material. The material can be soft metal, such as but not limited to NiTi. RRA 304 comprises two lines of holes 306 and 308. The holes can be arranged in a Zig-Zag form around a central virtual line of RRA 304. The picture 300 demonstrates how tight the bonded RRA 304 is to the surface of the teeth of the bottom jaw 302.

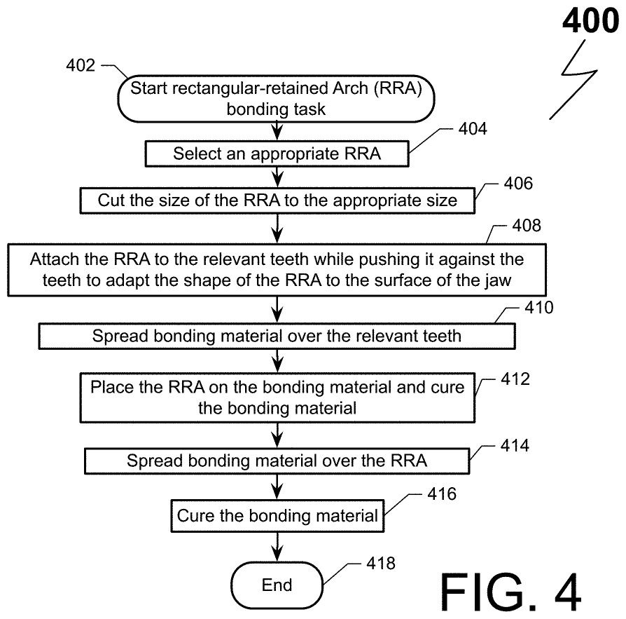

Referring now to FIG. 4 that illustrates a flowchart of a method 400 that can be implemented for bonding 402 an example of RRA to a jaw of a patient. At block 404 an appropriate RRA is selected. The selection can be based on the size ‘S’ (FIG. 1) of the RRA and the size of the jaw of the patient. Next a doctor may cut 406 the RRA to the exact size that fits the patient teeth.

At block 408 the RRA can be vertically attached 408 to the relevant teeth and be pushed against each tooth and the space between teeth in order to adapt the shape of the RRA to the surface of the lingual side of the jaw. Then, bonding material can be spread 410 over the relevant teeth. At block 412 the RRA can be placed 412 on the bonding material and be pushed 412 against the lingual side of the jaw. During this step 412, bonding material can be transferred, via the holes 106 (FIG. 1) or 306 and 308 (FIG. 3) from the space between the teeth and the RRA to the other side of the RRA for improving the holding of the RRA to the teeth, then the bonding material can be cured 412.

At block 414 bonding agent can be spread 414 over the bonded RRA. Finally the bonding agent can be cured 416 by (ultra violet) UV light or by chemical, for example. Then, process 400 can be terminated 418. In the present disclosure the terms glue, bonding material, bonding agent can be used interchangeably.

In the description and claims of the present disclosure, each of the verbs, “comprise”, “include”, “have”, and conjugates thereof, are used to indicate that the object or objects of the verb are not necessarily a complete listing of members, components, elements, or parts of the subject or subjects of the verb.

The present disclosure has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons skilled in the art that the present invention is not limited by what has been particularly shown and described herein above. Rather the scope of the invention is defined by the claims that follow.

1. A rectangular-retained arch (RRA) comprising:
a plurality of holes;
wherein the shape of the RRA is an arch;
wherein the size of the RRA is adapted to the size of a jaw to which it will be bonded; and
wherein the RRA is made of a single piece of material.

2. The RRA of claim 1, wherein the holes are arranged in one or more lines.

3. The RRA of claim 1, wherein the holes are configured to allow a bonding agent to penetrates to a side other than the side that is attached to the jaw.

4. The RRA of claim 1, wherein the material from which the RRA is made of is metal.

5. The RRA of claim 1, wherein the material from which the RRA is made is alloy of Nickle-Titanium (NiTi).

6. The RRA of claim 5, wherein the alloy of NiTi is configured to start moving toward its pre-deformation shape at a temperature which is 65 or more degrees Celsius.

7. The RRA of claim 1, wherein the arch is attached to the jaw in the vertical dimension.

8. The RRA of claim 1, wherein the side of the RRA that is configured to be bonded to the jaw was sandblasted.

9. The RRA of claim 1, wherein the size of the RRA that is adapted to the upper jaw is in the range of 34 to 42 mm.

10. The RRA of claim 1, wherein the size of the RRA that is adapted to the bottom jaw is in the range of 30 to 36 mm.

11. The RRA of claim 1, wherein the height of the RRA that is adapted to the upper jaw is in the range of 9 to 11 mm.

12. The RRA of claim 1, wherein the height of the RRA that is adapted to the bottom jaw is in the range of 8.5 to 9.5 mm.

13. The RRA of claim 1, wherein the width of the RRA is in the range of 0.8 to 1.3 mm.

14. The RRA of claim 1, wherein the thickness of the RRA is in the range of 0.13 to 0.19 mm.

15. A method of attaching a rectangular-retained arch (RRA) to teeth of a jaw of a patient, the method comprising:
i. selecting an RRA that it's dimension fits the jaw of the patient
ii. adapting the RRA to the surface of the teeth;
iii. spreading bonding material over the surface of the teeth;
iv. placing the RRA over the bonding material and pushing the RRA toward the surface of the teeth; and
v. curing the bonding material.

16. The method of claim 15, further comprising:
i. spreading bonding material over the RRA; and
ii. curing the bonding material.

17. The method of claim 15, wherein the action of adapting the RRA to the surface of the teeth comprising cutting the RRA to the appropriate size.
